(19) United States
(12) Patent Application Publication
(10) Pub. No.: US 2013/0223999 A1
(43) Pub. Date: Aug. 29, 2013

(54) DUAL-CHAMBER OIL PUMP

(71) Applicant: Timothy J. PAULSON, Schererville, IN (US)

(72) Inventor: Timothy J. PAULSON, Schererville, IN (US)

(21) Appl. No.: 13/408,717

(22) Filed: Feb. 29, 2012

(51) Int. Cl. F04D 29/40; B23P 15/00

(52) U.S. Cl. 415/182.1; 29/888.025

(57) ABSTRACT

An oil pump for a machine is disclosed. The oil pump may have a housing. The oil pump may further have a spacer fixedly connected to the housing. The spacer may divide the housing into a main chamber and an auxiliary chamber. The spacer may also have an opening. The oil pump may further have a drive shaft rotatably disposed within the housing generally orthogonal to the spacer. The drive shaft may pass through the opening. In addition, the oil pump may have a collar fixedly connected to the drive shaft. The collar may be positioned within the opening generally orthogonal to the spacer. The collar may have a diameter of about 2.5 to 3.0 inches and the opening may have a diameter such that an annular gap area between the collar and the spacer is about 0.25 to 0.29 square inches.

### TECHNICAL FIELD

The present disclosure relates generally to an oil pump and, more particularly, to an oil pump having dual chambers.

### BACKGROUND

Engines require oil for lubrication and cooling of moving mechanical parts. Diesel engines used on locomotives typically have a single oil pump with two separate chambers, including a main chamber that supplies oil to a number of moving parts of the engine and an auxiliary chamber that supplies oil to cool pistons of the engine. A spacer having two circular openings separates the two chambers from each other. A drive shaft passes through one of these openings and a collar mounted on the drive shaft is positioned within one of the openings such that there is an annular gap between the collar and walls of the opening. An idler shaft passes through the other opening in the spacer and is positioned such that there is an annular gap between the idler shaft and walls of the other opening. The annular gaps allow the rotating collar and the stationary or rotary idler shaft to interface freely between the two separate chambers without contacting the spacer.

A discharge pressure of oil in the main chamber of the pump is usually higher than a discharge pressure of oil in the auxiliary chamber. Oil may, therefore, leak from the main chamber to the auxiliary chamber through the two annular gaps causing a drop in pressure in the main chamber. It is desirable to reduce the amount of leakage between chambers to maintain the discharge pressures in the main and auxiliary chambers at desired levels.

The dual-chamber oil pump of the present disclosure solves one or more of the problems set forth above and/or other problems in the art.

### SUMMARY

In one aspect, the present disclosure is directed to an oil pump. The oil pump may include a housing. The oil pump may further include a spacer fixedly connected to the housing. The spacer may divide the housing into a main chamber and an auxiliary chamber. The spacer may also have an opening. The oil pump may include a drive shaft rotatably disposed within the housing generally orthogonal to the spacer. The drive shaft may pass through the opening. In addition, the oil pump may include a collar fixedly connected to the drive shaft. The collar may be positioned within the opening generally orthogonal to the spacer. The collar may have a diameter of about 2.5 to 3.0 inches and the opening may have a diameter such that an annular gap area between the collar and the spacer is about 0.25 to 0.29 square inches.

In another aspect, the present disclosure is directed to a method of remanufacturing an oil pump. The method may include removing an auxiliary chamber housing from a main chamber housing. The method may also include removing an auxiliary drive gear from a drive shaft. The method may further include removing a first spacer from the main chamber housing. In addition, the method may include removing a first collar from the drive shaft, the first collar being in contact with a main drive gear over a first contact bearing area. The method may also include fixedly mounting a second collar to the drive shaft. The second collar may have a diameter larger than a diameter of the first collar. The second collar may contact the main drive gear over a second contact bearing area larger than the first contact bearing area. The method may further include attaching a second spacer having an opening to the main chamber housing. The second spacer may be disposed generally orthogonal to the drive shaft and the second collar may be disposed within the opening. The opening may have a diameter such that an annular gap area between the second collar and the second spacer may be about 0.25 to 0.29 inches.

### BRIEF DESCRIPTION OF THE DRAWINGS

FIG. 1 is a pictorial illustration of an exemplary pump;

FIG. 2 is a pictorial illustration of a portion of the exemplary disclosed pump of FIG. 1; and

FIG. 3 is a cross-sectional illustration of the exemplary disclosed pump of FIG. 1.

### DETAILED DESCRIPTION

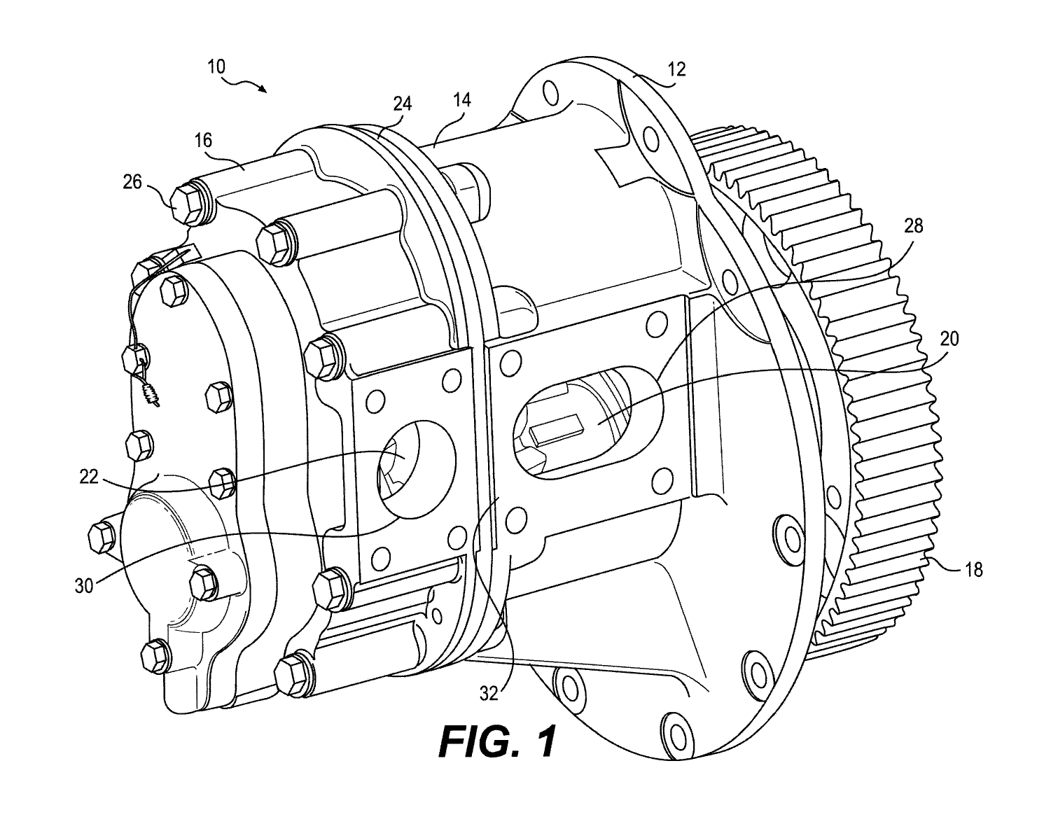

FIG. 1 illustrates a pump 10. Pump 10 may have a housing 12. In one embodiment, housing 12 may be a two-part housing with a main chamber housing 14 and an auxiliary chamber housing 16. Pump 10 may be driven by an external source of power (not shown), such as an internal combustion engine, via a drive gear 18. Drive gear 18 may be located on one end of pump 10 for engagement with the engine. Pump 10 may include a main chamber 20 and an auxiliary chamber 22. A spacer 24 may be sandwiched between main chamber housing 14 and auxiliary chamber housing 16 and may separate main chamber 20 from auxiliary chamber 22. Bolts 26 or other fasteners may be used to connect main chamber housing 14, spacer 24, and auxiliary chamber housing 16 to each other.

Main chamber 20 may supply oil to lubricate and cool a number of moving parts of the engine through an outlet port 28 located at a front face 32 of pump 10. For example, main chamber 20 may supply oil to cool and lubricate main bearings (not shown), crankshaft bearings (not shown), connecting rod bearings (not shown), camshaft and rocker assemblies (not shown), gear train (not shown), etc. Main chamber 20 may have an inlet port (not shown) corresponding to outlet port 28 and located at a rear face (not shown) of pump 10. Auxiliary chamber 22 may supply oil to cool pistons (not shown) in the engine through an outlet port 30 located at a front face 32 of pump 10. Auxiliary chamber 22 may have an inlet port (not shown) corresponding to outlet port 30 and located at a rear face of pump 10.

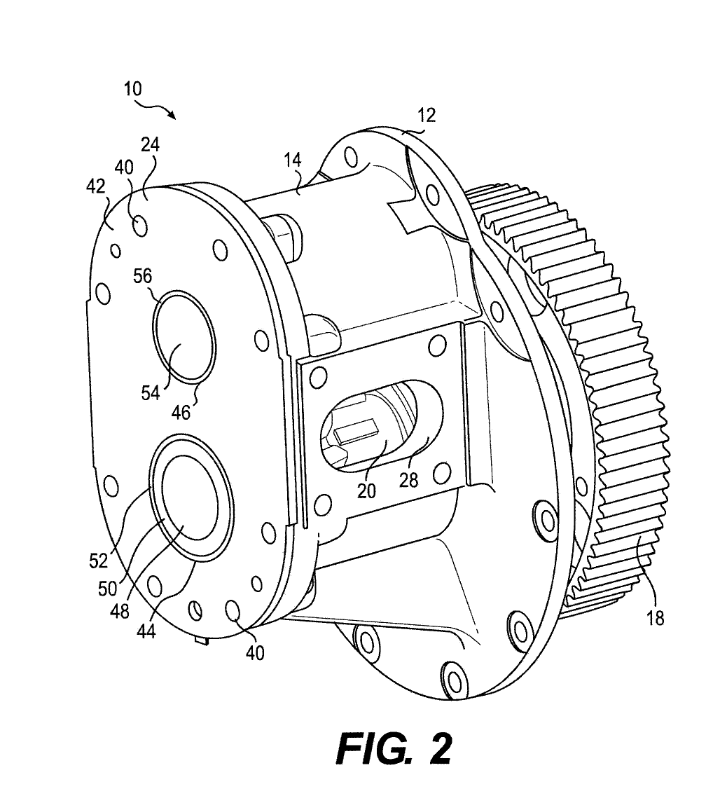

As illustrated in FIG. 2, spacer 24 may include bolt holes 40 configured to receive bolts 26. Bolt holes 40 may be uniformly spaced along a peripheral portion 42 of spacer 24. The thickness of spacer 24 may be selected to withstand pressures generated within pump 10 during its operation. In one exemplary embodiment, the thickness of spacer 24 may range from about 0.36 to 0.38 inches. Spacer 24 may include a first opening 44 and a second opening 46. In one embodiment, first and second openings 44 and 46, respectively, may be circular. First opening 44 may have a diameter larger than a diameter of second opening 46. It is contemplated, however, that second opening may have a diameter equal to or larger than first opening 44, if desired.

A drive shaft 48 may pass through first opening 44 and may be disposed generally orthogonal to spacer 24. Drive shaft 48 may be connected to rotate with drive gear 18. That is, as drive gear 18 is rotated by the engine or another external power source, drive shaft 48 may rotate with drive gear 18. A collar 50 may be mounted on drive shaft 48 and positioned to rotate within first opening 44 such that an annular gap 52 may be formed between collar 50 and first opening 44. Drive shaft 48, collar 50, and first opening 44 may be positioned co-axially with respect to each other. Collar 50 may be attached to drive shaft 48 by, for example, interference fit, welding, keyed fit, or in any other appropriate manner so that collar 50 may rotate together with drive shaft 48. An idler shaft 54 may be disposed generally orthogonal to spacer 24 and may pass through second opening 46 such that an annular gap 56 may be formed between idler shaft 54 and second opening 46. Idler shaft 54 may be positioned co-axially with respect to second opening 46. Annular gap 52 may be determined in terms of an annular gap area between collar 50 and first opening 44. Likewise, annular gap 56 may be determined in terms of an annular gap area between idler shaft 54 and second opening 46.

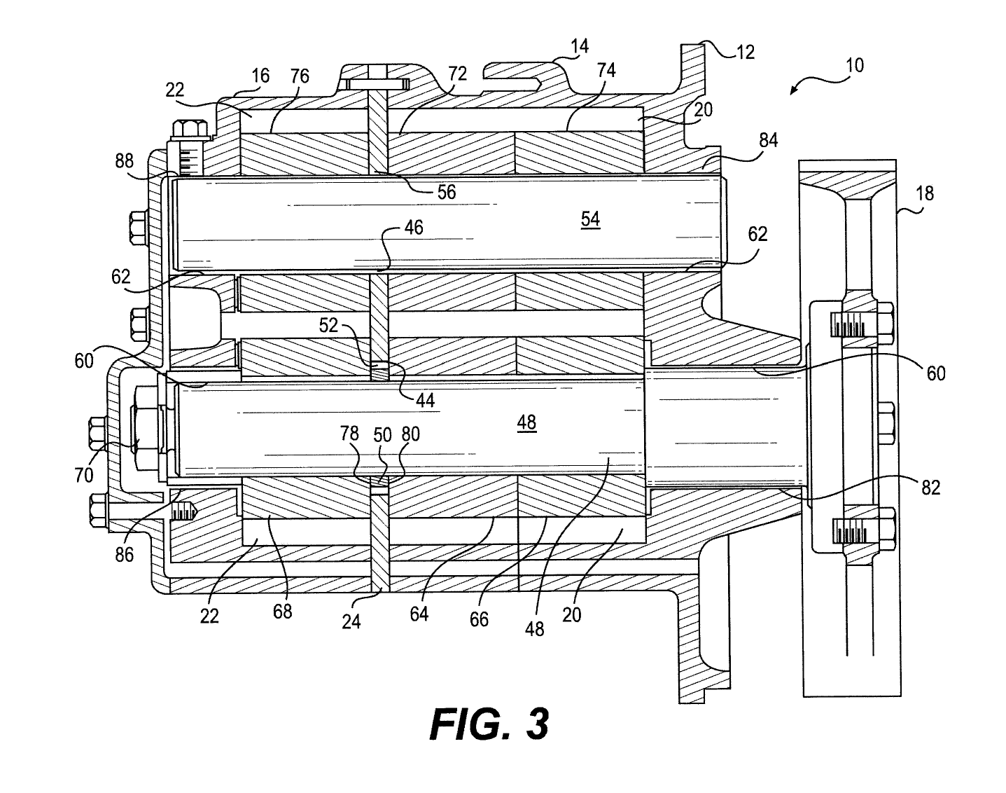

As illustrated in FIG. 3, drive shaft 48 may be supported by bearings 60 attached to housing 12 at either end of drive shaft 48. Bearings 60 mounted near drive gear 18 may be collocated with opening 82 in main chamber housing 14. Bearings 60 mounted on the other end of drive shaft 48 may be collocated with opening 86 in auxiliary chamber housing 16. Idler shaft 54 may similarly be supported by bearings 62 attached to housing 12 at either end of idler shaft 54. Bearings 62 may be collocated with opening 84 in main chamber housing 14 and opening 88 in auxiliary chamber housing 16, respectively. Main drive gears 64 and 66 may be located in main chamber 20 and may be mounted on drive shaft 48. Auxiliary drive gear 68 may be located in auxiliary chamber 22 and may also be mounted on drive shaft 48. Although FIG. 3 shows two main drive gears 64, 66 and one auxiliary drive gear 68, one skilled in the art would understand that any number of main drive gears and auxiliary drive gears may be used in pump 10.

Main drive gears 64 and 66 and auxiliary drive gear 68 may be mounted on drive shaft 48 using keys (not shown). It is contemplated that any other appropriate method known in the art, for example, interference fit, welding, etc., may be used to mechanically attach gears 64, 66, and 68 to drive shaft 48, if desired. Retention nut 70 may be used to axially connect main drive gears 64,66, collar 50, and auxiliary drive gear 68 allowing them to rotate in unison with drive shaft 48.

Main idler gears 72 and 74 may be located in main chamber 20 and mounted on idler shaft 54. An auxiliary idler gear 76 may be located in auxiliary chamber 22 and mounted on idler shaft 54. Main idler gears 72, 74 and auxiliary idler gear 76 may be mounted on idler shaft 54 using keys (not shown). It is contemplated that any other appropriate method known in the art, for example, interference fit, welding, etc., may be used to mechanically attach gears 72, 74, and 76 to idler shaft 54, if desired. In some embodiments, the idler shaft may remain stationary and main idler gears 72, 74 and auxiliary idler gear 76 may rotate about the idler shaft. Although FIG. 3 shows two main idler gears 72 and 74, and one auxiliary idler gear 76, one skilled in the art would understand that any number of main idler gears and auxiliary idler gears may be used in pump 10.

Gears 64, 66, 68, 72, 74, and 76 may be helical gears. It is contemplated that gears 64, 66, 68, 72, 74, and 76 may alternatively be other types of gears, for example, spur gears, double helical gears, or any other type of gears known in the art, if desired. Main idler gears 72 and 74 may mesh with main drive gears 64 and 66, respectively. Likewise, auxiliary idler gear 76 may mesh with auxiliary drive gear 68. In an exemplary embodiment, each of gears 64, 66, 68, 72, 74, and 76 may have about 17 teeth, a pressure angle of about 28 degrees, and a helix angle of about 10 degrees. It is contemplated, however, that gears 64, 66, 68, 72, 74, and 76 may have any other appropriate number of teeth, pressure angles, and helix angles.

As gears 64, 66, 68, 72, 74, and 76 rotate out of mesh, oil may be drawn in from the inlet ports in main and auxiliary chambers 20 and 22 and pressurized when it is trapped between the gear teeth on gears 64, 66, 68, 72, 74, and 76 and inner walls of housings 12. Further, as gears 64, 66, 68, 72, 74, and 76 rotate in mesh, oil that was previously trapped between the gear teeth and the inner walls of housing 12 may be expelled through outlet ports 28 and 30. A flow rate of oil from main chamber 20 through outlet port 28 may be higher than a flow rate of oil from auxiliary chamber 22 through outlet port 30. In one exemplary embodiment, the flow rate of oil from main chamber 20 may range from about 63 to 281 gallons per minute whereas the flow rate of oil from auxiliary chamber 22 may range from about 32 to 136 gallons per minute.

The axial pressure applied by retention nut 70 may allow auxiliary drive gear 68, collar 50, and main drive gears 64, 66 to move as one unit with drive shaft 48. The axial pressure may be exerted over contact bearing area 78 between auxiliary drive gear 68 and collar 50 and contact bearing area 80 between collar 50 and main drive gear 64. In one embodiment, collar 50 may have a thickness larger than that of spacer 24, to allow the axial load from retention nut 70 to be applied to main drive gears 64, 66, auxiliary drive gear 68, and collar 50, but not to spacer 24. For example, in one embodiment, the thickness of collar 50 may range from about 0.39 to 0.42 inches. In other embodiments, collar 50 may have a thickness smaller than that of spacer 24, and additional collars (not shown) mounted on main drive shaft 48 may ensure that the axial load from retention nut 70 is not applied to spacer 24.

A diameter of collar 50 may be selected to be as large as possible to increase the size of contact bearing areas 78 and 80. Increasing the size of contact bearing areas 78 and 80 in this manner may reduce the mechanical stresses generated in main drive gears 64, 66 and auxiliary drive gear 68, thus reducing the likelihood of stress-related cracking of these gears. In one embodiment the diameter of collar 50 may range from about 2.5 to 3.0 inches to provide the desired size of contact bearing areas 78 and 80. Increasing the diameter of collar 50, without changing a radial gap between collar 50 and first opening 44, however, may increase the size of annular gap 52 causing more oil to leak from main chamber 20 to auxiliary chamber 22.

During operation of pump 10, a discharge pressure generated in main chamber 20 may be higher than a discharge pressure generated in auxiliary chamber 22. In one exemplary embodiment, the discharge pressure in main chamber 20 may range from about 100 to 110 psi whereas the discharge pressure in auxiliary chamber 22 may range from about 70 to 75 psi. When discharge pressure in main chamber 20 is higher than that in auxiliary chamber 22, oil may leak from main chamber 20 to auxiliary chamber 22 through annular gaps 52 and 56. Larger annular gaps 52 and 56 may allow too much oil to leak from main chamber 20 to auxiliary chamber 22 and may also decrease the discharge pressure generated in main chamber 20. Smaller annular gaps 52 and 56 may reduce the amount of oil that leaks from main chamber 20 to auxiliary chamber 22. If annular gaps 52 and 56 are too small, however, collar 50 and/or idler shaft 54 may touch spacer 24, become incapable of rotating freely, and may damage spacer 24. Thus, it is desirable to increase a diameter of collar 50 to enlarge contact bearing areas 78 and 80 while simultaneously reducing annular gap 52 to reduce the leakage of oil from main chamber 20 to auxiliary chamber 22.

Annular gap 52 may be reduced in many ways. For example, annular gap 52 may be reduced by decreasing a diameter of first opening 44 such that annular gap 52 is as small as possible while still allowing collar 50 to rotate freely within first opening 44. In one exemplary embodiment, first opening 44 may have a diameter ranging from about 2.56 to 3.06 inches. In another exemplary embodiment, a diameter of first opening 44 may be selected such that an area of annular gap 52 may range from about 0.25 to 0.29 square inches. Annular gap 52 may also be decreased by decreasing the allowable tolerances on collar 50 and/or first opening 44. In one exemplary embodiment, the machining tolerances on collar 50 may range from about 0 inches to 0.001 inches. In another exemplary embodiment, the machining tolerances on a diameter of first opening 44 may be about ±0.01 inches.

Similar design choices for a diameter of idler shaft 54 and a diameter of second opening 46 may be used to decrease annular gap 56. For example, annular gap 56 may be decreased by decreasing a diameter of second opening 46 such that annular gap 56 is as small as possible while still allowing idler shaft 54 to rotate freely within second opening 46. In one exemplary embodiment, second opening 46 may have a diameter ranging from about 2.0 to 2.2 inches. In another exemplary embodiment, a diameter of second opening 46 may be selected such that an area of annular gap 56 may range from about 0.07 to 0.10 square inches. Annular gap 56 may also be reduced by decreasing the allowable machining tolerances on a diameter of second opening 46. In one exemplary embodiment, the machining tolerances on a diameter of second opening 46 may be about ±0.01 inches.

### INDUSTRIAL APPLICABILITY

The disclosed pump may be used in any machine or power system application where it is necessary to supply oil for cooling a number of moving parts of the engine and for cooling pistons within the engine. The disclosed oil pump may find particular applicability with large mobile machines such as locomotives and marine engines because it provides a mechanism to supply oil to different parts of an engine without requiring separate dedicated pumps.

Pump 10 may be periodically disassembled for inspection. For example, it may be necessary to inspect gears 64, 66, 68, 72, 74, and 76 to determine whether they are damaged and need to be replaced. If one or more of these gears is damaged, pump 10 may be remanufactured using replacement parts. Moreover, a first collar 50 may be replaced by a second collar 50 having a diameter larger than first collar 50 thereby providing larger contact bearing areas 78 and 80.

Remanufacture of pump 10 may include removing auxiliary chamber housing 16 from pump 10. Removing auxiliary chamber housing 16 may involve removal of bolts 26 or any other fasteners used to attach main chamber housing 14, first spacer 24 and auxiliary chamber housing 16. Retention nut 70 may be loosened and removed. Auxiliary drive gear 68 may be removed from drive shaft 48. Removal of auxiliary drive gear 68 may involve removal of a key or other mechanical fastener used to mount auxiliary drive gear 68 to drive shaft 48. Auxiliary idler gear 76 may similarly be removed from idler shaft 54.

A first spacer 24 may be removed from pump 10. A first collar 50 may be removed from drive shaft 48. Removal of first collar 50 may involve removal of a key or other mechanical fastener used to mount collar 50 on drive shaft 48. Main drive gears 64, 66 may be removed from drive shaft 48. Like auxiliary drive gear 68, removal of main drive gears 64, 66 may involve removal of a key or other fastener used to attach main drive gears 64, 66 to drive shaft 48. Main idler gears 72, 74 may be similarly removed from idler shaft 54.

Each of gears 64, 66, 68, 72, 74, and 76 may be inspected using visual inspection to identify any damage to the gears. Alternatively, gears 64, 66, 68, 72, 74, and 76 may be inspected using ultrasonic or other methods known in the art for detecting stress related damage. If any of gears 64, 66, 68, 72, 74, and 76 is damaged, a replacement gear may be used in place of the damaged gear.

A second collar 50 may be selected for use in remanufactured pump 10. Second collar 50 may have a diameter larger than first collar 50 to provide larger contact bearing areas 78 and 80 between auxiliary drive gear 68 and second collar 50 and between main drive gear 64 and second collar 50, respectively.

During assembly of the remanufactured pump, main drive gears 64 and 66 may be mounted onto drive shaft 48 using a key or any other appropriate mechanical attachment method. Likewise, second collar 50 may be mounted on drive shaft 48 using an interference fit or any other appropriate mechanical attachment method. Main idler gears 72 and 74 may be mounted on idler shaft 54 using a key or any other appropriate mechanical attachment method. Main idler gears 72 and 74 may mesh with main drive gears 64 and 66, respectively.

Second spacer 24 may be placed such that second collar 50 is positioned within first opening 44 with an annular gap 52 and idler shaft 54 is positioned within second opening 46 with an annular gap 56. Dimensions of first and second openings 44 and 46 may be selected so that the sizes of annular gaps 52 and 56 are reduced while allowing second collar 50 and idler shaft 54 to freely rotate within first and second openings 44 and 46, respectively. By reducing annular gaps 52 and 56, leakage of oil from a main chamber 20 to an auxiliary chamber 22 of pump 10 may be decreased.

Auxiliary drive gear 68 may be mounted on drive shaft 48 using a key or any other appropriate mechanical attachment method. Bearings 60 may also be attached to drive shaft 48. Retention nut 70 may be attached to the end of drive shaft 48 and torqued so that an axial pressure may be exerted between auxiliary drive gear 68, second collar 50, and main drive gears 64 and 66. Likewise, auxiliary idler gear 76 may be mounted on idler shaft 54 using a key or any other appropriate mechanical attachment method. Auxiliary idler gear 76 may mesh with auxiliary drive gear 68.

Auxiliary chamber housing 16 may be positioned so that bearings 60 and 62 may be collocated with openings 86 and 88, respectively, in auxiliary chamber housing 16. Bolts 26 may be inserted through bolt holes (not shown) in auxiliary chamber housing 16 and bolt holes 40 in spacer 24 and fastened to main chamber housing 14.

It will be apparent to those skilled in the art that various modifications and variations can be made to the disclosed oil pump without departing from the scope of the disclosure. Other embodiments of the oil pump will be apparent to those skilled in the art from consideration of the specification and practice of the oil pump disclosed herein. It is intended that the specification and examples be considered as exemplary only, with a true scope of the disclosure being indicated by the following claims and their equivalents.

What is claimed is:

1. An oil pump comprising:
a housing;
a spacer fixedly connected to the housing and dividing the housing into a main chamber and an auxiliary chamber, the spacer having an opening;
a drive shaft rotatably disposed within the housing generally orthogonal to the spacer and passing through the opening; and
a collar fixedly connected to the drive shaft and positioned within the opening generally orthogonal to the spacer, wherein the collar has a diameter of about 2.5 to 3.0 inches and the opening has a diameter such that an annular gap area between the collar and the spacer is about 0.25 to 0.29 square inches.

2. The oil pump of claim 1, further including:
a main drive gear located in the main chamber and fixedly connected to the drive shaft; and
an auxiliary drive gear located in the auxiliary chamber and fixedly connected to the drive shaft, such that the collar is disposed between the main drive gear and the auxiliary drive gear.

3. The oil pump of claim 2, wherein a thickness of the collar is greater than a thickness of the spacer.

4. The oil pump of claim 3, wherein the thickness of the spacer is about 0.36 to 0.38 inches.

5. The oil pump of claim 4, wherein the opening is a first opening and the spacer includes a second opening.

6. The oil pump of claim 5, further including an idler shaft stationarily or rotatably disposed within the housing generally orthogonal to the spacer and passing through the second opening such that an annular gap area between the idler shaft and the spacer is about 0.07 to 0.10 square inches.

7. The oil pump of claim 6, wherein the housing is a two-part housing.

8. The oil pump of claim 7, wherein the first opening in the spacer has a diameter of about 2.56 to 3.06 inches.

9. The oil pump of claim 8, wherein the second opening in the spacer has a diameter of about 2.0 to 2.2 inches.

10. The oil pump of claim 9, wherein the discharge pressure in the main chamber is greater than the discharge pressure in the auxiliary chamber.

11. The oil pump of claim 10, wherein the discharge pressure in the main chamber is about 100 to 110 psi.

12. The oil pump of claim 11, wherein the discharge pressure in the auxiliary chamber is about 70 to 75 psi.

13. The oil pump of claim 14, wherein a flow of oil from the main chamber is about 63 to 281 gpm.

14. The oil pump of claim 15, wherein a flow of oil from the auxiliary chamber is about 32 to 136 gpm.

15. A method of remanufacturing an oil pump, including:
removing an auxiliary chamber housing from a main chamber housing;
removing an auxiliary drive gear from a drive shaft;
removing a first spacer from the main chamber housing;
removing a first collar from the drive shaft, the first collar being in contact with a main drive gear over a first contact bearing area;
fixedly mounting a second collar to the drive shaft, the second collar having a diameter larger than a diameter of the first collar and contacting the main drive gear over a second contact bearing area larger than the first contact bearing area;
fixedly mounting the auxiliary drive gear to the drive shaft, such that the collar is disposed between the main drive gear and the auxiliary drive gear;
attaching a second spacer having an opening to the main chamber housing such that the second spacer is disposed generally orthogonal to the drive shaft and the second collar is disposed within the opening, wherein the opening has a diameter such that an annular gap area between the second collar and the second spacer is about 0.25 to 0.29 square inches.

16. The method of claim 15, wherein the second collar has a diameter ranging from about 2.5 to 3.0 inches.

17. The method of claim 16, wherein the opening in the second spacer has a diameter ranging from about 2.56 to 3.06 inches.

18. The method of claim 17, wherein the diameter of the second collar has a machining tolerance ranging from about 0 to 0.001 inches.

19. The method of claim 18, wherein the opening in the second spacer has a machining tolerance ranging from about −0.001 to +0.001 inches.

20. The method of claim 19, wherein a thickness of the second collar is greater than a thickness of the second spacer.
